(19) United States
(12) Patent Application Publication
(10) Pub. No.: US 2016/0151783 A1
(43) Pub. Date: Jun. 2, 2016

(54) ANALYSIS DEVICE AND DETECTING MODULE

(71) Applicant: HTC Corporation, Taoyuan County (TW)

(72) Inventors: Sheng-Chieh Lin, Taoyuan County (TW); Pin-Chung Sun, Taoyuan County (TW); Yao-Ting Tseng, Taoyuan County (TW); Chung-Ju Wu, Taoyuan County (TW); Chien-Lung Huang, Taoyuan County (TW)

(21) Appl. No.: 14/555,690

(22) Filed: Nov. 28, 2014

(51) Int. Cl. B01L 3/00; G01N 27/327

(52) U.S. Cl. CPC B01L 3/502715; G01N 27/327; B01L 2300/0816; B01L 2300/0645; B01L 2300/0867; B01L 2400/0487; B01L 2200/025; B01L 2200/027; B01L 2200/0689

(57) ABSTRACT

An analysis device including a detecting module and a main module is provided. The detecting module includes a first body having an injection opening and a sample liquid, a first connector and a detecting chip disposed at the first body and electrically connected with each other. The main module includes a second body, an injection element and a second connector disposed at the second body. The detecting module is adapted to connect with the main module by corresponding the injection opening with the injection element and corresponding the first connector with the second connector, wherein the injection element injects a reagent liquid into the first body through the injection opening, the detecting chip analyzes a mixture of the reagent liquid and the sample liquid to generates an electrical signal, and the electrical signal is transmitted to the main module through the first connector and the second connector.

### BACKGROUND OF THE APPLICATION

1. Field of the Application

The present application generally relates to an analysis device and a detecting module, more particularly, to a liquid analysis device and a detecting module thereof.

2. Description of Related Art

In recent year, miniaturized biochemical detecting modules have been developed rapidly, and many miniaturized biochemical detecting modules have been broadly applied in various analysis devices. Benefits of the miniaturized biochemical detecting modules include quick analysis, accurate quantification, low sample volume, space-saving and etc., and thus many detecting modules have gradually been developed towards miniaturization, and have even been integrated into a detecting chip (e.g., a biochip).

In miniaturized biochemistry, processes of mixing a sample liquid with a reagent liquid to produce a reaction or separate out a portion of the contents may be executed in a miniaturized detecting module configured with a biochip, such as a test cassette configured with a biochip. The sample liquid and the reagent liquid, after executing a series of the aforementioned biochemical reactions in the miniaturized detecting module, may enable the biochip to generate an electrical signal, whereby the electrical signal may be received by a signal unit of the analysis device, so that biological characteristics of the sample liquid may be obtained by analyzing the electrical signal. However, since an injection unit for injecting the reagent liquid into the detecting module and the signal unit for transmitting the electrical signal are usually disposed on different devices, operations for performing the biochemical analysis are relatively complicated.

### SUMMARY OF THE APPLICATION

The present application is directed to an analysis device having a liquid injection function and an electrical signal transmission function, thereby providing a simpler operational method.

The present application provides a detecting module applicable in an analysis device for detecting a sample liquid.

The analysis device of the present application includes a detecting module and a main module. The detecting module includes a first body, a first connector and a detecting chip. The first body has an injection opening, and a sample liquid is adapted to be disposed in the first body. The first connector is disposed on the first body and located at a side of the injection opening. The detecting chip is disposed within the first body and electrically connected with the first connector. The detecting module is adapted to be assembled to the main module. The main module includes a second body, an injection element and a second connector. The injection element is disposed on the second body. The second connector is disposed on the second body and located at a side of the injection element. The detecting module is adapted to connect with the main module by corresponding the injection opening with the injection element and corresponding the first connector with the second connector, wherein the injection element injects a reagent liquid into the first body through the injection opening, so that the sample liquid and the reagent liquid are mixed with each other to form a mixture in the first body. The detecting chip analyzes the mixture of the reagent liquid and the sample liquid to generate an electrical signal, and the electrical signal is transmitted to the main module through the first connector and the second connector.

The detecting module of the present application includes a first body, a first connector and a detecting chip. The first body has an injection opening, wherein a sample liquid is adapted to be disposed in the first body, and an injection element is adapted to inject a reagent liquid into the first body through the injection opening, so that the sample liquid and the reagent liquid are mixed with each other to form a mixture in the first body. The first connector is disposed on the first body and located at a side of the injection opening. The detecting chip is disposed within the first body and electrically connected with the first connector. The detecting chip analyzes the mixture of the reagent liquid and the sample liquid to generate an electrical signal. The electrical signal is transmitted to an analysis device through the first connector.

In view of the above, in the detecting module of the present application, the reagent liquid is injected into the first body through the injection opening and is mixed with the sample liquid disposed in the first body, and the detecting chip analyzes the mixture of the reagent liquid and the sample liquid to generate the electrical signal. As such, in the analysis device of the present application, the detecting module is connected with the main module by corresponding the injection opening with the injection element and corresponding the first connector with the second connector. The main module injects the reagent liquid from the injection opening into the first body of the detecting module through the injection element, and the electrical signal generated via analyzing the mixture of the reagent liquid and the sample liquid by the detecting chip is transmitted to the main module through the first connector and the second connector. Consequently, the detecting module of the present application may be applied in the analysis device for detecting the sample liquid, whereby the analysis device has the liquid injection function and the electrical signal transmission function, and thus provides a simpler operational method.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view illustrating an analysis device according to an embodiment of the present invention.

FIG. 2 is a top view illustrating the analysis device of FIG. 1 after being assembled.

FIG. 3 is a schematic cross-sectional view illustrating the analysis device of FIG. 2 along an A-A′ line.

FIG. 4 is a schematic cross-sectional view illustrating an analysis device according to another embodiment of the present invention.

FIG. 5 is a schematic top view illustrating the detecting module of FIG. 2.

### DESCRIPTION OF THE EMBODIMENTS

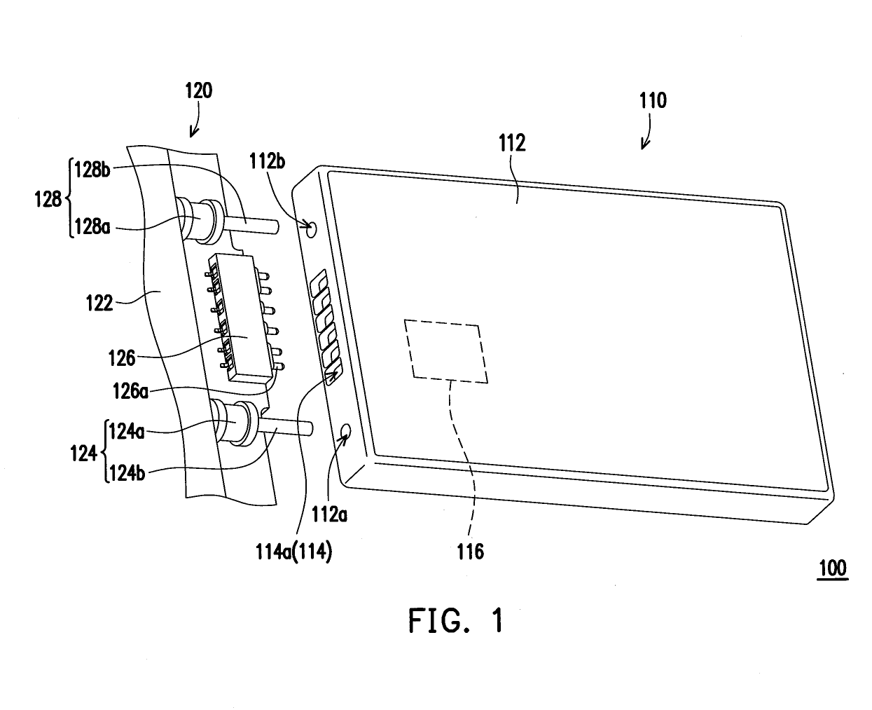

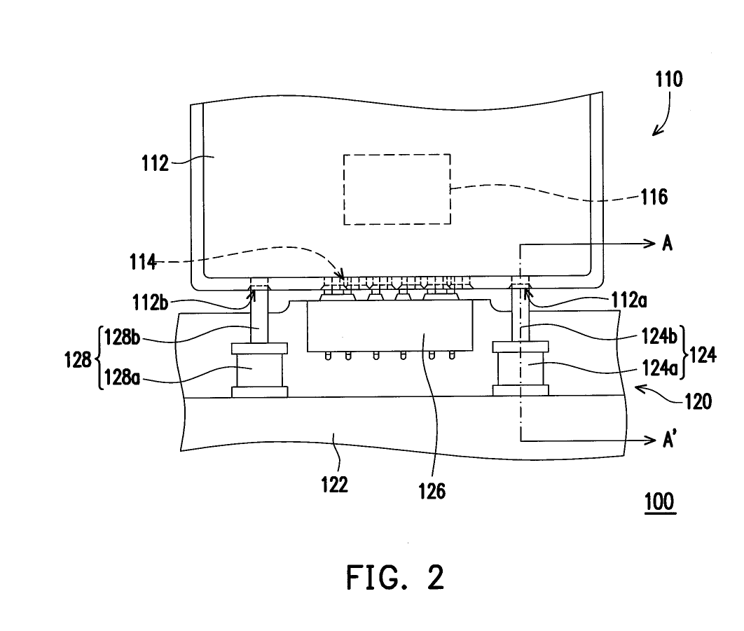

FIG. 1 is a perspective view illustrating an analysis device according to an embodiment of the present invention. FIG. 2 is a top view illustrating the analysis device of FIG. 1 after being assembled. Referring to FIG. 1 and FIG. 2, in the present embodiment, an analysis device 100 includes a detecting module 110 and a main module 120. The detecting module 110 includes a first body 112, a first connector 114 and a detecting chip 116. The first body 112 has an injection opening 112a, and a sample liquid (not shown) is adapted to be disposed in the first body 112. The first connector 114 is disposed on the first body 112 and located at a side of the injection opening 112a. The detecting chip 116 is disposed within the first body 112 and electrically connected with the first connector 114. Moreover, the detecting module 110 is adapted to be assembled to the main module 120. The main module 120 includes a second body 122, an injection element 124 and a second connector 126. The injection element 124 is disposed on the second body 122. The second connector 126 is disposed on the second body 122 and located at a side of the injection element 124. As such, the detecting module 110 is adapted to connect with the main module 120 by corresponding the injection opening 112a with the injection element 124 and corresponding the first connector 114 with the second connector 126, wherein the injection element 124 injects a reagent liquid (not shown) into the first body 112 through the injection opening 112a, so that the sample liquid and the reagent liquid are mixed with each other to form a mixture in the first body 112. The detecting chip 116 analyzes the mixture of the reagent liquid and the sample liquid to generate an electrical signal, and the electrical signal is transmitted to the main module 120 through the first connector 114 and the second connector 126. Consequently, the detecting module 110 of the present embodiment may be applied in the analysis device 100 for detecting the sample liquid, whereby the analysis device 100 have a liquid injection function and an electrical signal transmission function, and thus provides a simpler operational method.

Specifically, in the present embodiment the detecting module 110 is configured to carry the sample liquid (not shown), and the main module 120 is adapted to provide the reagent liquid for mixing with the sample liquid. After the sample liquid and the reagent liquid have gone through a series of mixing and separation procedures in the firs body 112 of the detecting module 110, the detecting chip 116 analyzes the mixture of the reagent liquid and the sample liquid and accordingly generates the electrical signal, and the electrical signal is transmitted to the main module 120 through the first connector 114 and the second connector 126. As such, the main module 120 may further be equipped with relevant analysis software for analyzing the biological characteristics of the sample liquid and the reagent liquid according to the electrical signal. Furthermore, in the present embodiment, the sample liquid is, for example, blood, and the reagent liquid is, for example, phosphate buffered saline (PBS). Hence, the detecting chip 116 of the present embodiment may be a biochip, but the present application does not intend to limit the types of the sample liquid, the reagent liquid and the detecting chip 116. Based on the type and the required analysis items of the sample liquid, the type of the reagent liquid may also be adjusted correspondingly. After the reagent liquid and the sample liquid are reacted in the first body 112 of the detecting module 110, a biochip served as the detecting chip 116 analyzes the mixture of the reagent liquid and the sample liquid and generates the electrical signal, and the electrical signal is corresponded to the biological characteristics of the reagent liquid and the sample liquid after reacted with each other. Thus, after the electrical signal is transmitted to the main module 120 through the first connector 114 and the second connector 126, the main module 120 may analyze the biological characteristics of the sample liquid according to the electrical signal.

Accordingly, in the present embodiment, since the main module 120 is configured to provide the reagent liquid for reacting with the sample liquid, the main module 120 injects the reagent liquid pre-stored in the second body 122 from the injection opening 112a of the first body 112 into the first body 112 of the detecting module 110 through the injection element 124 protruded from the second body 122. In addition, the first body 112 of the detecting module 110 has micro channel structures (as described in the following) therein. The main module 120 injects the reagent liquid into the first body 112, so that after the reagent liquid and the sample liquid disposed in the first body 112 are converged, the reagent liquid and the sample liquid may be mixed with each other through flowing in the micro channel structures within the first body 112. The mixture of the reagent liquid and the sample liquid flows through the detecting chip 116 for allowing the detecting chip 116 to analyze the mixture of the reagent liquid and the sample liquid and to generate the electrical signal. Furthermore, in the present embodiment, the first connector 114 and the second connector 126 may be connected with each other in correspondence, wherein the first connector 114 is, for example, a receptacle connector, and the second connector 126 is, for example, a plug connector, but the present application does not intend to limit the types of the first connector 114 and the second connector 126. Therefore, the electrical signal generated by the detecting chip 116 may be transmitted to the main module 120 through the first connector 114 and the second connector 126.

Moreover, in the present embodiment, the detecting module 110 further includes another injection opening 112b, and the main module 120 further includes another injection element 128. The injection openings 112a and 112b are disposed on the first body 112 and are respectively located at two opposites sides of the first connector 114. Similarly, the injection elements 124 and 128 are disposed on the second body 122 and are respectively located at two opposite sides of the second connector 126. As such, the injection element 128 is adapted to be inserted into the corresponding injection opening 112b. After the mixture of the sample liquid and the reagent liquid flows through the detecting chip 116 to enable the detecting chip 116 to generate the electrical signal, the injection element 128 may inject a cleaning fluid (not shown) into the first body 112 for cleaning out impurities on the detecting chip 116, thereby improving an accuracy of the detection. Accordingly, it can be known that the present application does not intend to limit the amounts and the locations of the injection element and the injection opening, and the amounts or the locations thereof may be adjusted according to the needs.

Based on the above, in the analysis device 100, when the detecting module 110 and the main module 120 are assembled together, the injection elements 124 and 128 are correspondingly inserted into the injection openings 112a and 112b, so as to inject the reagent liquid and the cleaning fluid into the first body 112; and at the same time, a plurality of terminals 126a of the second connector 126 are correspondingly inserted into a plurality of ports 114a of the first connector 114 for transmitting the electrical signal generated by the detecting chip 116. Accordingly, it can be known that the present embodiment integrates the liquid injection function and the electrical signal transmission function corresponding to the detecting module 110 into a single main module 120. With the aforementioned assembling actions, the analysis device 100 of the present embodiment may execute a liquid injection function and an electrical signal transmission function. In other words, with the aforementioned configurations, an operational method of the analysis device 100 may be simplified. As a result, the analysis device 100 of the present embodiment has the liquid injection function and the electrical signal transmission function, thereby providing a simpler operational method.

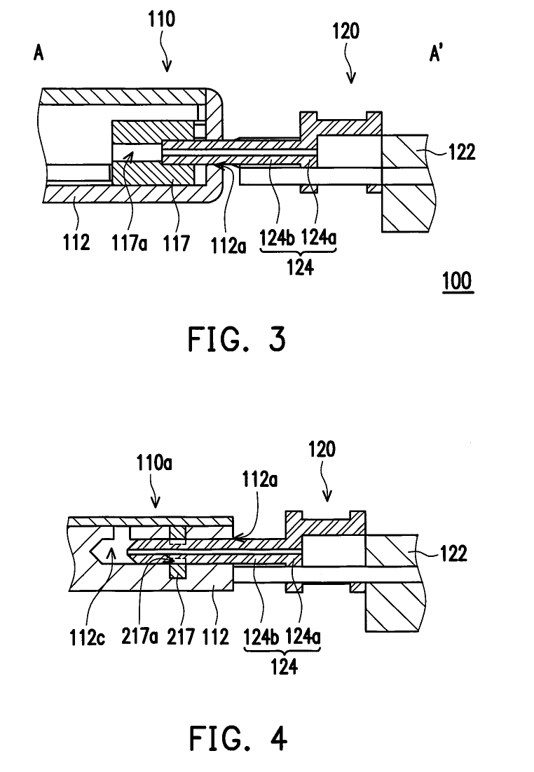

FIG. 3 is a schematic cross-sectional view illustrating the analysis device of FIG. 2 along an A-A′ line. Referring to FIG. 1 through FIG. 3, in the present embodiment, the injection element 124 of the main module 120 includes a fixed portion 124a and an inserting portion 124b. The injection element 124 is fixed at the second body 122 with the fixed portion 124a and is adapted to be inserted into the injection opening 112a with the inserting portion 124b. In other words, the inserting portion 124b of the injection element 124 extends outwardly from the fixed portion 124a fixed on the second body 122 to present a pin shape and thus is adapted to be inserted into the injection opening 112a. However, the present application does not intend to limit the shape of the injection element 124, which may be adjusted according to the needs. Moreover, in the present embodiment, the detecting module 110 further includes a sealing member 117. The sealing member 117 is disposed within the first body 112 and corresponded to the injection opening 112a, so as to prevent the reagent liquid that is injected into the first body 112 through the injection element 124 from flowing out from the injection opening 112a. Specifically, the sealing member 117 is, for example, a rubber or other suitable material, and has flexibility and water-resistance, but the present application is not limited thereto. The sealing member 117 is disposed at the injection opening 112a and has a channel 117a, and the channel 117a penetrates through the sealing member 117 and connects with the injection opening 112a. As such, the injection element 124 is adapted to be inserted into the first body 112 from the injection opening 112a and penetrate through the channel 117a, so as to enable the reagent liquid to be injected into the first body 112 of the detecting module 110 through the injection opening 112a and the channel 117a. Furthermore, a diameter of the channel 117a of the sealing member 117 is, preferably, slightly smaller than a diameter of the inserting portion 124b of the injection element 124. When the injection element 124 is inserted into the first body 112 from the injection opening 112a via the inserting portion 124b, the inserting portion 124b penetrates into the channel 117a by squeezing the interior of the channel 117a, and the injection element 124, after penetrating into the channel 117a via the inserting portion 124b, forms a tight fit state with the sealing member 117. As such, with the blockage of the sealing member 117, the reagent liquid that is injected into the first body 112 through the injection element 124 may be prevented from flowing out from the injection opening 112a. Similarly, the injection element 128 includes a fixed portion 128a and an inserting portion 128b, wherein the injection element 128 is fixed at the second body 122 with the fixed portion 128a and is adapted to be inserted into the injection opening 112b with the inserting portion 128b, and the injection opening 112b may also be configured with the aforementioned sealing member 117; and relative details will not be repeated again.

FIG. 4 is a schematic cross-sectional view illustrating an analysis device according to another embodiment of the present invention. Referring to FIG. 4, in the present embodiment, a detecting module 110a has a similar structure and uses as the detecting module 110, and a main difference therebetween lies in that, a sealing member 217 of the detecting module 110a is different from the sealing member 117 of the detecting module 110. Specifically, in the present embodiment, the sealing member 217 is disposed within the first body 112 and corresponded to the injection opening 112a, so as to prevent the reagent liquid that is injected into the first body 112 through the injection element 124 from flowing out from the injection opening 112a. Wherein, the first body 112 of the present embodiment has a channel 112c, and the channel 112c connects with the injection opening 112a. In addition, the sealing member 217 is disposed at the channel 112c of the first body 112 and has a through hole 217a, and the through hole 217a penetrates through the sealing member 217 and connects with the channel 112c. As such, the injection element 124 is adapted to be inserted into the first body 112 from the injection opening 112a and penetrate through the through hole 217a to be corresponded to the channel 112c, so as to enable the reagent liquid to be injected into the first body 112 of the detecting module 110a through the injection opening 112a and the channel 112c. Furthermore, a thickness of the sealing member 217 is smaller than a length of the channel 112c, and a diameter of the through hole 217a of the sealing member 217 is far smaller than a diameter of the inserting portion 124b of the injection element 124. As such, when the injection element 124 is inserted into the first body 112 from the injection opening 112a with the inserting portion 124b, since the thickness of the sealing member 217 is thinner, the inserting portion 124b may penetrate through the through hole 217a via squeezing the through hole 217a, and the inserting portion 124b is corresponded to the channel 112c after penetrating through the through hole 217a. As such, with the blockage of the sealing member 217, the reagent liquid that is inserted into the first body 112 through the injection element 124 may be prevented from flowing out from the injection opening 112a. Similarly, the injection opening 112b may also be configured with the aforementioned sealing member 217; and relative details will not be repeated again. It can be known from the above that the present application does not intend to limit the implementation of the sealing member, and it can be adjusted according to the needs.

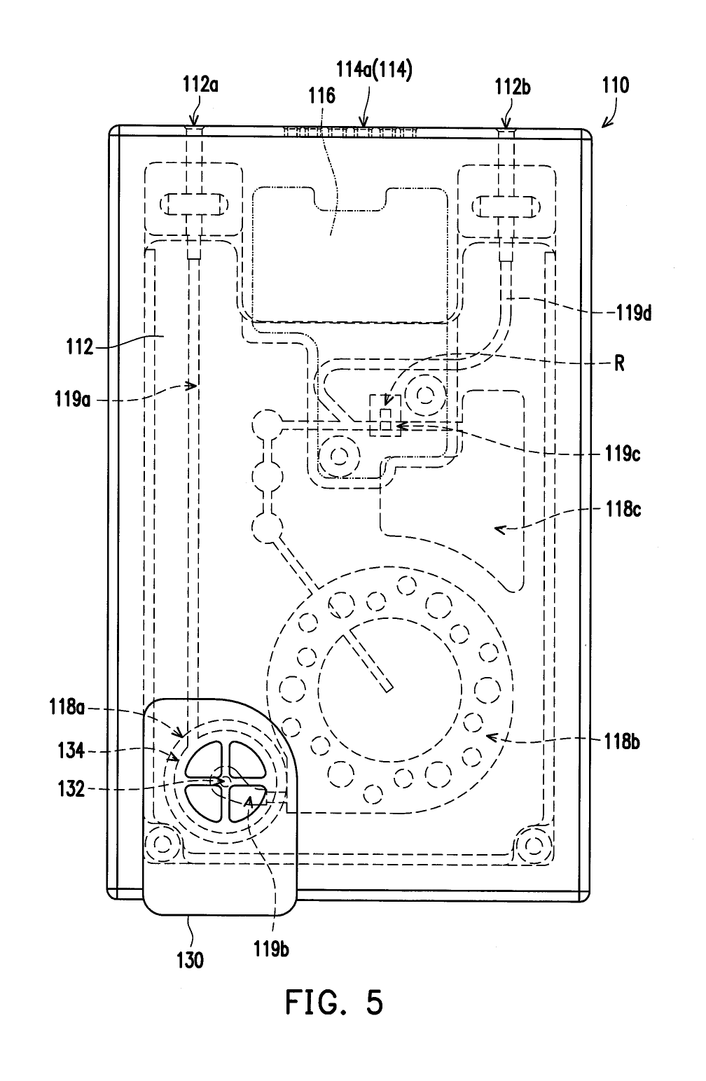

FIG. 5 is a schematic top view illustrating the detecting module of FIG. 2. Referring to FIG. 1, FIG. 2 and FIG. 5, in the present embodiment, the detecting module 110 is configured to carry the sample liquid (not shown) and enable the reagent liquid (not shown) and the sample liquid to execute the mixing and separation processes, so that the detecting chip 116 can analyze the mixture of the reagent liquid and the sample liquid to generate the electrical signal and provide the electrical signal to the main module 120. The first body 112 of the detecting module 110 has micro channel structures therein, so as to enable the reagent liquid and the sample liquid to mix and react with each other through flowing in the micro channel structures within the first body 112; and the reagent liquid and the sample liquid after being mixed and reacted with each other then flow through the detecting chip 116, so as to enable the detecting chip 116 to generate the electrical signal accordingly. The following provides an implementation of the micro channel structures, but the present application is not limited thereto.

Specifically, in the present embodiment, the detecting module 110 includes an accommodating recess 118a, a first channel 119a, a connecting channel 119b, a mixing recess 118b, and a second channel 119c. The accommodating recess 118a is disposed in the first body 112, and the sample liquid is adapted to be disposed in the accommodating recess 118a. The first channel 119a is disposed within the first body 112 and communicates with the injection opening 112a and the accommodating recess 118a containing the sample liquid. The mixing recess 118b is disposed within the first body 112 and communicates with the accommodating recess 118a containing the sample liquid and the second channel 119c through the connecting channel 119b. The second channel 119c is disposed within the first body 112 and communicates with the accommodating recess 118a containing the sample liquid and a measurement region R containing the detecting chip 116. As such, the reagent liquid is injected into the first body 112 from the injection opening 112a through the injection element 124 (shown in FIG. 1 and FIG. 2), wherein the reagent liquid flows from the injection opening 112a through the first channel 119a and into the accommodating recess 118a, and then flows through the connecting channel 119b into the mixing recess 118b after carrying along the sample liquid within the accommodating recess 118a, so as to be mixed with the sample liquid in the mixing recess 118b. After being mixed and reacted with each other in the mixing recess 118b, the reagent liquid and the sample liquid flow through the second channel 119c into the measurement region R, and the detecting chip 116 disposed in the measurement region R analyzes the mixture of the sample liquid and the reagent liquid to generate the electrical signal. The aforementioned micro channel structures, which include the accommodating recess 118a, the first channel 119a, the connecting channel 119b, the mixing recess 118b and the second channel 119c, are all disposed within the first body 112, and thus the first body 112 of the present embodiment may be made of two splints (not shown); and the micro channel structures are, namely, grooves or trenches disposed on each of the splints, and are located between the splints after the splints are combined with each other. Hence, in FIG. 5, the micro channel structures located between the splints are illustrated with dashed-lines. The aforementioned micro channel structures are connected with each other, so as to constitute a continuous flow path within the first body 112 (between the splints); and the reagent liquid and the sample liquid are mixed and reacted with each other through flowing in the micro channel structures within the first body 112.

Moreover, in the present embodiment, the analysis device 100 further includes a slight volume collector 130 disposed on the first body 112 of the detecting module 110 and located within the accommodating recess 118a. The slight volume collector 130 is adapted to accommodate and quantify the sample liquid and be assembled within the accommodating recess 118a, and the reagent liquid is adapted to flow from the first channel 119a, through the slight volume collector 130 within the accommodating recess 118a and carry along the sample liquid, and then through the connecting channel 119b into the mixing recess 118b, so as to be mixed with the sample liquid. Furthermore, the slight volume collector 130 of the present embodiment has a through hole 132 and a channel 134 which are connected with each other. After the slight volume collector 130 collecting the sample liquid and being assembled within the accommodating recess 118a, the channel 134 of the slight volume collector 130 is communicated with the first channel 119a, and the through hole 132 is communicated with the connecting channel 119b and the mixing recess 118b. As such, the first channel 119a, the channel 134, the through hole 132, the connecting channel 119b and the mixing recess 118b constitute a continuous flow path; and the reagent liquid and the sample liquid are disposed on different locations of the flow path. For instance, the reagent liquid adopts the injection opening 112a as a starting position, and the sample liquid adopts the through hole 132 of the slight volume collector 130 as a starting position. Therefore, the reagent liquid flows from the first channel 119a into the channel 134 of the slight volume collector 130, and then flows through the connecting channel 119b into the mixing recess 118b after carrying along the sample liquid in through hole 132. Nevertheless, the slight volume collector 130 is merely one of the implementations in the present application for disposing the sample liquid; the present application is not limited thereto. For instance, the sample liquid may also be disposed in the accommodating recess 118a by direct instillation, or be disposed in the accommodating recess 118a after carried by other container. Thus, it can be known that the present application does not intend to limit the approach for disposing the sample liquid in the first body, and the approach may be adjusted according to the needs.

Furthermore, in the present embodiment, the first body 112 of the detecting module 110 may further be configured with a waste liquid recess 118c therein according to the needs. The waste liquid recess 118c is communicated with an end of the second channel 119c. After a portion of the liquid is separated from the liquid mixture formed by mixing the reagent liquid and the sample liquid and flows to the measurement region R disposed with the detecting chip 116, the used liquid mixture (i.e., the mixture that has enabled the detecting chip 116 to generate the electrical signal) may pass through the second channel 119c and flows into the waste liquid recess 118c, namely, the used liquid mixture are being collected by the waste liquid recess 118c. In other words, after the liquid mixture formed by mixing the reagent liquid and the sample liquid flows through the measurement region R via the second channel 119c to enable the detecting chip 116 disposed in the measurement region R to generate the electrical signal, the liquid mixture flows and concentrates into the waste liquid recess 118c via the second channel 119c. Nevertheless, the present application does not intend to limit whether the waste liquid recess 118c is to be disposed or not, and the disposition can be adjusted accordingly to the needs. In addition, since the analysis device 100 of the present embodiment may further inject the cleaning fluid into the first body 112 through the injection element 128 (as shown in FIG. 1 and FIG. 2), the detecting module 110 of the present embodiment may further include a third flow channel 119d, which is connected with the injection opening 112b and the second channel 119c and located between the measurement region R and the mixing recess 118b. As such, when the injection element 128 injects the cleaning fluid into the first body 112, the cleaning fluid flows into the second channel 119c through the third flow channel 119d and then through the measurement region R. Thus, the cleaning fluid can be used to clean impurities on the detecting chip 116, so as to improve an accuracy of the detection. Afterward, the cleaning fluid carrying the residues may flow through the second channel 119c and into the waste liquid recess 118c. The aforementioned micro channel structures are only provided for illustrating one the embodiment of the present application, and are not provided for limiting the scope of the present application.

Referring to FIG. 1, FIG. 2 and FIG. 5 again, in the present embodiment, the detecting module 110 is configured with the aforementioned micro channel structures in the first body 112 according to the needs, so as to enable the reagent liquid that is injected into the first body 112 of the detecting module 110 from the injection element 124 of the main module 120 to be mixed and reacted with the sample liquid in the first body 112. Afterward, the detecting chip 116 analyzes the mixture of the reagent liquid and the sample liquid to generate the electrical signal accordingly, and to transmit the electrical signal to the main module 120 through the first connector 114 and the second connector 126. Hence, the detecting module 110 of the present application may be applied in the analysis device 100 for detecting the sample liquid, wherein a liquid injection function and an electrical signal transmission function required thereby are already integrated into the main module 120. As such, after assembling together the detecting module 110 and the main module 120, the analysis device 100 may perform a series of the aforementioned steps, and thus the operational method of the analysis device may be simplified. Consequently, the detecting module 110 of the present application may be applied in the analysis device 100 for detecting the sample liquid, whereby the analysis device 100 has a liquid injection function and an electrical signal transmission function, and thus provides a simpler operational method.

In summary, in the detecting module of the present application, the reagent liquid is injected into the first body through the injection opening and is mixed with the sample liquid disposed with in the first body, and the detecting chip analyzes the mixture of the reagent liquid and the sample liquid to generate the electrical signal. As such, in the analysis device of the present application, the detecting module is connected with the main module by corresponding the injection opening with the injection element and corresponding the first connector with the second connector. The main module injects the reagent liquid from the injection opening into the first body of the detecting module through the injection element, wherein the detecting module further include the sealing member disposed within the first body and corresponding to the injection opening, so as to prevent the reagent liquid injected into the first body through the injection element from flowing out from the injection opening. The electrical signal generated via analyzing the mixture of the reagent liquid and the sample liquid by the detecting chip is transmitted to the main module through the first connector and the second connector. That is, the present application integrates the liquid injection function and the electrical signal transmission function required by the detecting module into a single main module, so as to simplify the operational method of the analysis device. Consequently, the detecting module of the present application may be applied in the analysis device for detecting the sample liquid, whereby the analysis device has a liquid injection function and an electrical signal transmission function, and thus provides a simpler operational method.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An analysis device, comprising:
a detecting module, comprising:
a first body, having an injection opening, and a sample liquid being adapted to be disposed in the first body;
a first connector, disposed on the first body and located at a side of the injection opening; and
a detecting chip, disposed within the first body and electrically connected with the first connector; and
a main module, the detecting module being adapted to be assembled to the main module, the main module comprising:
a second body;
a injection element, disposed on the second body; and
a second connector, disposed on the second body and located at a side of the injection element, the detecting module being adapted to connect with the main module by corresponding the injection opening with the injection element and corresponding the first connector with the second connector, wherein the injection element injects a reagent liquid into the first body through the injection opening, so that the sample liquid and the reagent liquid are mixed with each other to form a mixture in the first body, the detecting chip analyzes the mixture of the reagent liquid and the sample liquid to generate an electrical signal, and the electrical signal is transmitted to the main module through the first connector and the second connector.

2. The analysis device as recited in claim 1, wherein the injection element comprises a fixed portion and an inserting portion, and the injection element is fixed at the second body with the fixed portion and is adapted to be inserted into the injection opening with the inserting portion.

3. The analysis device as recited in claim 1, wherein the detecting module further comprises a sealing member disposed within the first body and corresponded to the injection opening.

4. The analysis device as recited in claim 3, wherein the sealing member is disposed at the injection opening and has a channel, the channel connects with the injection opening, and the injection element is adapted to be inserted into the first body from the injection opening and penetrate through the channel, so as to enable the reagent liquid to be injected into the first body through the injection opening and the channel.

5. The analysis device as recited in claim 3, wherein the first body has a channel, the channel connects with the injection opening, the sealing member is disposed at the channel and has a through hole, and the injection element is adapted to be inserted into the first body from the injection opening and penetrate through the through hole to be corresponded to the channel, so as to enable the reagent liquid to be injected into the first body through the injection opening and the channel.

6. A detecting module, comprising:
a first body, having an injection opening, wherein a sample liquid is adapted to be disposed in the first body, and an injection element is adapted to inject a reagent liquid into the first body through the injection opening, so that the sample liquid and the reagent liquid are mixed with each other to form a mixture in the first body;
a first connector, disposed on the first body and located at a side of the injection opening; and
a detecting chip, disposed within the first body and electrically connected with the first connector, the detecting chip analyzes the mixture of the reagent liquid and the sample liquid to generate an electrical signal, and the electrical signal is transmitted to an analysis device through the first connector.

7. The detecting module as recited in claim 6, further comprising:
a sealing member, disposed within the first body and corresponded to the injection opening.

8. The detecting module as recited in claim 7, wherein the sealing member is disposed at the injection opening and has a channel, the channel connects with the injection opening, and the injection element is adapted to be inserted into the first body from the injection opening and penetrate through the channel, so as to enable the reagent liquid to be injected into the first body through the injection opening and the channel.

9. The detecting module as recited in claim 7, wherein the first body has a channel, the channel connects with the injection opening, the sealing member is disposed at the channel and has a through hole, and the injection element is adapted to be inserted into the first body from the injection opening and penetrate through the through hole to be corresponded to the channel, so as to enable the reagent liquid to be injected into the first body through the injection opening and the channel.

10. The detecting module as recited in claim 6, further comprising:
a slight volume collector, disposed on the first body, the slight volume collector being adapted to accommodate and quantify the sample liquid, and the reagent liquid being adapted to flow through the slight volume collector and carry along the sample liquid, so as to be mixed with the sample liquid.

11. The detecting module as recited in claim 6, further comprising:
a first channel, disposed within the first body and communicating with the injection opening and the sample liquid, so as to enable the reagent liquid to flow into the first channel from the injection opening and to carry the sample liquid.

12. The detecting module as recited in claim 6, further comprising:
a second channel, disposed within the first body and communicating with the sample liquid and the detecting chip, so as to enable the reagent liquid and the sample liquid to flow to the detecting chip through the second channel after mixing with each other.

13. The detecting module as recited in claim 12, further comprising:
a mixing recess, disposed within the first body and communicating with the sample liquid and the second channel, so as to enable the reagent liquid to be mixed with the sample liquid in the mixing recess after carrying along the sample liquid, and then enable the reagent liquid and the sample liquid to flow to the detecting chip through the second channel after being mixed.
